(19) United States
(12) Patent Application Publication
(10) Pub. No.: US 2011/0307815 A1
(43) Pub. Date: Dec. 15, 2011

(54) User Interface and Method for Collecting Preference Data Graphically

(75) Inventors: Kenneth Ellis Nichol Lampinen, Espoo (FI); Timo Tapani Koponen, Espoo (FI); Harri Koponen, Stockholm (SE)

(73) Assignee: MYGOBS OY, Espoo (FI)

(21) Appl. No.: 12/813,543

(22) Filed: Jun. 11, 2010

(51) Int. Cl. G06F 3/048

(52) U.S. Cl. 715/765; 715/767

(57) ABSTRACT

The present invention enables a user to intuitively collect and share information on his personal preferences and priorities through the relational placement of graphical objects in a graphical user interface. This information can then, with the express permission of the end user, be used by Internet services to deliver highly personalized services. Additionally, the present invention allows a computer system to measure user preferences and perceptions and to use that information for Internet services to deliver highly customized versions of their service.

### BACKGROUND OF THE INVENTION

1. Field of Invention

The present invention relates generally to a novel graphical user interface and method of using said graphical user interface to graphically collect user preference data. Additionally, there the graphical user interface is able to be adapted based on the preference data as well as to display additional information according to user preference data.

2. Description of Related Art

As the amount of information available to users of computer systems increases, being able to provide users with relevant information becomes exponentially more difficult. In order to provide users with the most relevant information it is preferable to have some preference data from the users. Preference data is virtually any type of data which allows a system to narrow or organize information, primarily information for display or presentation to the user.

Computer systems have collected preference data from users in a variety of manners in the past. The most basic form of collecting preference data is a settings or options menu where a user can see the preference data they can modify and can interact accordingly. The problem with such menus is that the amount of preference data which can be collected is often limited and generic. When such menus allow for an extended amount of preference data to be collected, it is often tedious to go through everything and often times only a small fraction of the modifiable attributes in the menu are of interest to the user.

Preference data collected in settings and options menus also have the drawback that the preference data is only applicable to the specific entity, i.e. program or website, which collects the data. For example, most search results are organized by relevance to the search query. However, if a user prefers to normally see search results displayed in order of when the information was available, that user must modify the options in every program or on virtually every website they go to separately.

An additional drawback to settings and options menus is that the preference data is usually just related to how the program functions. There is no place in a settings menu to enter that a user likes fish more than meat or one car brand over another.

In order to collect preference data about users likes and dislikes, it has become common to prompt a user to enter rating data when viewing or after viewing information. Programs such as music libraries prompt users to rate and rank songs, artists, albums, etc. They either do so actively, such as immediately after a song, or passively by having a rating bar, such as a line of five stars, next to each song that the user can voluntarily utilize.

Websites, such as hotel and airline sites, often allow visitors to log in and set preference such as liking aisle seats over window seats, or 1^{st} floor rooms over upper floor rooms. However, it is often necessary to select such data on each site separately, even though the information is the same for all hotels or airlines.

Therefore, there exists a need in computer systems to collect preference data in one place that is specific and relevant to each user and to make that preference data available to other programs, websites and parts of the system. Additionally, there exists a need to collect such data unobtrusively, preferably such that the user does not even know what preference data they are entering.

### SUMMARY OF THE INVENTION

It is an object of the present invention to provide a method for collecting preference data from a user which overcome at least some of the drawbacks of the prior art. Furthermore, it is an object of the present invention to provide a user interface which facilitates the method and allows for the collecting of preference data from a user which overcomes at least some of the drawbacks of the prior art.

It is a further object of the present invention to collect the preference data from the user graphically and in such a way that the collection is not intrusive to the user.

It is yet a further object of the present invention to collect preference data that is applicable to a variety of preferences of the user and to make relevant portions of the preference data available to corresponding portions of a system.

One embodiment of the graphical user interface according to the present invention allows a user to place and manipulate graphical objects in a virtual space or in a plurality of virtual spaces. Images or icons representative of specific entities or data are available to be spatially placed amongst other images and icons in relation to a focus image or icon. Data is collected about each image or icon and used to form preference data about the user.

In said embodiment, if a user has an icon representing a Ford auto in a section representing the present and an icon representing a BMW auto in a section representing the future, the present system could determine an aspirational is preference of the user for BMW. If the user then has a third icon representing a Fiat auto in his present section, but the Fiat icon is further away from the focus image than the Ford icon, then system can determine a current preference for Ford over Fiat.

The system can then feed this data, preferably with the user's permission, to a used car search service. The service can use the preference data relevant to cars to deliver search results for the user where BMW, Ford and Fiat (in that order) are prioritized in the search results.

Time data on when a gob placed in a user's collection can also be collected and used by the system. In the interface, when objects are placed in the same, or relatively same location, the more recently placed gob is measured as having a slightly higher level of preference than the older gob.

In addition to using the data in a user's own collection, the present invention can also incorporate data from a user's network, i.e., the collections of icons and preference data in a user's friend's collections, preferably to the third level.

In the above example auto example, if the end user has a friend who has an Opel gob in their collection, the car search service could then deliver prioritized search results with Opel before other brands that were not in the end-user's collection.

The present invention will now be disclosed in more detail with the aid of the figures and exemplary embodiments.

### BRIEF DESCRIPTION OF THE DRAWINGS

FIG. 1 shows a user interface in a present view at the present date.

FIG. 2 shows a user interface in a present view at a past date.

FIG. 3 shows a user interface in a present view at a date in the past.

FIG. 4 shows a user interface in a past view.

FIG. 5 shows a user interface in a future view.

FIG. 6 shows a user interface in a navigation view.

FIG. 7 shows a user interface with advertisements and suggestions.

FIG. 8 shows a user interface with expanded content.

### DETAILED DESCRIPTION OF EXEMPLARY EMBODIMENTS

The present invention provides a novel user interface which is capable of collecting data which is either preference data of the user or can be used to determine preference data of a user. Preferably, the user interface contains a plurality of graphical objects which are able to be manipulated and moved within the user interface. The way in which the user manipulates and places the graphical objects provides the user interface and associated system with the data to be used for creating preference data.

Preferably, the user interface contains several views capable of collecting preference data based on user interaction with the interface. Different views may allow the user to prioritize information in different ways. Some examples of views are present, past and future views. Such views can be distinct from one another or they can be different portions of a single view.

A user is able to place graphical objects in the view that is most appropriate to them. If a user is a college student, then graphical objects representative of high school can be placed in the past view. Graphical objects representative of information or entities currently important or from college can be place in the present view. The user can also place graphical objects representative of perspective jobs, graduate schools or nice cars in the future view which will become more important when the user graduates or is near to graduating.

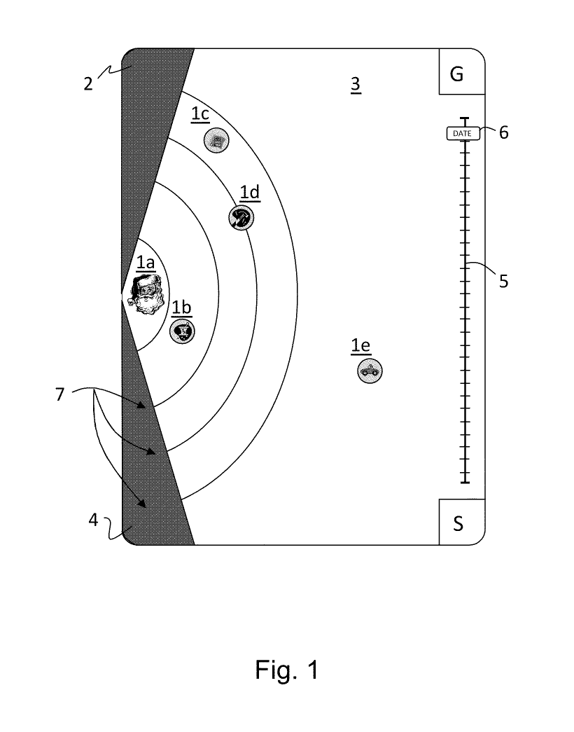

In primary views, it is preferable to have a large amount of space to place, move and manipulate graphical objects so that the most preference data can be collected at one time. Examples of primary views are FIGS. 1-5. In the exemplary embodiments of the primary views, graphical objects can be moved and placed on the plane of the screen and are not bound to a single axis of movements or placement.

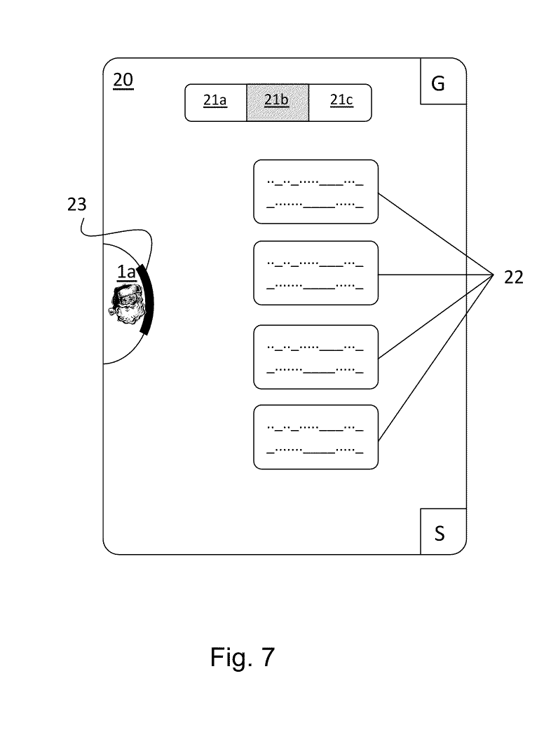

In addition to primary views, the user interface can contain one or more secondary views. Secondary views preferably display information from the primary views. Secondary views such as FIG. 7 present information and data from the graphical objects from the primary views. In these views, graphical objects that are present can be limited to movement along a single axis which allows accurate placement of graphical objects with respect to others. Secondary views can also be expanded views of a specific graphical object or set of graphical objects.

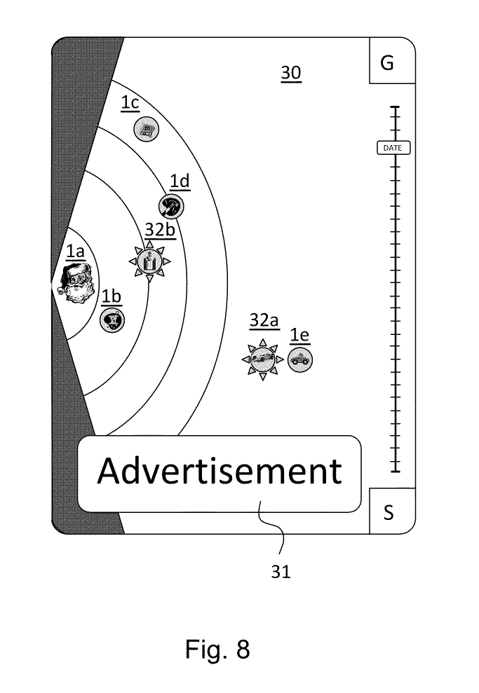

The user interface can also contain Tertiary views which provide a service to the user such as suggestions, search results, advertisements etc. While such services can be incorporated in to primary and secondary views, it can be preferable to have them in separate tertiary views such as FIG. 8.

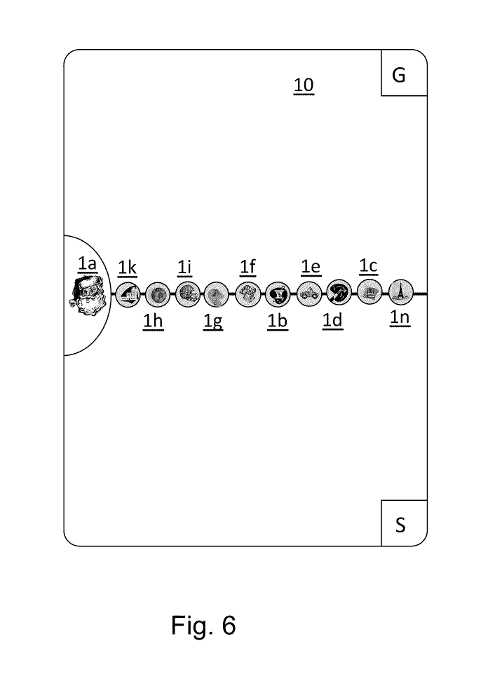

The user interface can contain additional views such as a settings menu, login menu, navigation screen etc. FIG. 6 shows an example of a navigation view. The following are examples of each of the types of views.

FIG. 1 shows an example of a graphical user interface, GUI, displaying a primary view 3 which represents the present. The GUI also shows partial views of future view 2 and past view 4. In the present example, the partial views are merely representations of the other views. However, the partial views can show some content contained in the views or it is conceivable that they can show all of the content in minimized form.

A plurality of rings 7 radiate from the left side of the display. In the present example, each ring is half of a concentric oval. The number, shape, size and point of radiation for rings 7 may differ either according to a designer's choice or based on user input to the system. The purpose of the plurality of rings is two-fold. First, they are meant to provide reference points for the user so that a user visually knows how far from a set point each graphical object is. The second purpose is that the rings can define different zones in the display which have different properties which can affect data and graphical objects separately.

It is preferable that there is a central set point with which a user can place graphical objects in respect to distance wise. Located in a central position along the left wall, at the radiation point for the rings 7 is a focus graphical object 1a. While in the present example, the central set point is represented with its own graphical object 1a the spot can be marked in another manner. However, whatever representation is at the focus point is what the preference data will be collected with respect to.

In the present example, the focus graphical object 1a represents the user of the system. The area of the display then contains a plurality of user inputted graphical objects 1b-e located at various distances from the focus graphical object 1a and at various distances from the representations of the past 4 and future 2 views.

An advantage of the present interface, system and method is the variety of preference data that can be collected in an easy and non-intrusive manner. However, it is not always necessary to collect every type of preference data. Therefore the designer of the system, or a user, may limit some of the functionality of the system and interface based on the type of preference data required or their own preferences.

A user can place the graphical objects virtually anywhere in the white portion of the interface representative of the present. Therefore, any graphical objects in the present view are assigned a data indicator which states the graphical object is presently important to the user. If a graphical object in the present view is no longer of present importance to a user, they can drag or move the graphical object to the past or future views. In one embodiment, the user can drag the graphical object to the representation of the past or future view which will remove the object from the present view and place it automatically in the desired view for movement and manipulation in that view.

Within the present view, a user can place any graphical object at any distance from the focus object 1 a and any distance from the past and future representations. Therefore, the user can place the graphical object within the plane of the display, i.e. in a 2-D space with respect to two axis of movement. Object 1b is show closest to the focus object, within the area between the focus ring and the first ring 7, and slightly closer to the past than to the future. From this simple placement by the user, the system can determine that relative to all of the other graphical objects added by the user in the system, this is the most important to the user presently. All objects placed at the same distance from the focus object, regardless of distances from the alternative views can be given the same data indicator about relative preference. Alternatively, a data indicator can be given separately for each object indicative of its relative location to an alternative view. Therefore, object 1b would be indicated as being slightly less relevant than an object located at the same distance from the focus object but closer to the future representation.

Additionally, objects within set boundaries can be assigned the same data indicator with respect to distance from the focus object regardless of variation within the boundaries. This is specifically useful when there is a large number of graphical objects in the display or if means for manipulating the objects in the display is not as accurate as desired. Examples of such boundaries would be within two rings, or anything touching a set ring, etc.

It is preferable that data representative of the exact coordinates of the placed graphical object are collected and used for determining preference data. Therefore, two objects that are close to each other, but located at slightly different coordinates will provide different preference data. However, it can be preferable that only a general coordinate of a placed graphical object is collected or that a set or predetermined range of exact collected coordinates can be used to determine similar or identical preference data for closely placed graphical objects as discussed above. Both options can be selectable by a user or system operator in a single GUI or a specific GUI may only contain one or the other of the options.

In the present example of FIG. 1, it can be determined by the system that the users prefers objects 1b-e in the order of 1b, 1d, 1c and 1e based on distance placement from the focus object. Additionally, the system can determine that is perceived time relevance of the user for the objects, from currently present to less currently present is 1e, 1b, 1d and 1c. The system can then determine that perceived time relevance of the user for the objects, from future to the past is 1c, 1d, 1e and 1b.

Apart from the actual placement, the system, through the GUI, can gather information such as how often a object is selected or viewed, when it was placed or moved, how often the object is moved and in what manner it is moved and manipulated. Once data and data indicators are collected the system can determine, through basic or complex functions, a set of preference data about a user and objects. The preference data can then be used as is, or manipulated, by other portions of the system or by third party services.

Graphical objects in the present invention are preferably images or icons which represent either an entity or other data. They can be links to data, information, menus, programs, webpages, folders, additional graphical objects, graphical objects bonding societies, etc. Ideally, the images or icons are representative of the entity or information which they represent. In the case of webpages the graphical object can be a miniature view of a portion or all of the webpage. In the case of information about a person they could be a picture of the person. In the case of a product it can be a picture of the product or a trademark of the product or the like.

The image or icon can be selected by the user, it can be automatically assigned by the system, it can be selected by the owner or representative entity which the graphical object represents or other like manners. The graphical object can also be a generic image, background or symbol accompanied by text.

Furthermore, it is preferable that the all of the images or icons are of similar size. In the present example of FIG. 1, all of the graphical images have identical boundaries and backgrounds with unique images placed on the background so that they are all identically shaped. However, the images could have uniquely shaped boarders, boarders that are the borders of the image or icon. Additionally, the graphical objects can be of different sizes. Sizing data can be used for determining preference data, such as relative importance, when the size of the graphical object is selectable by the user. Other parameters of the graphical object, when selectable by the user, can also contribute to the preference data. For instance, different background colors and boundary shapes can be selected by the user to represent different data indicators.

Graphical objects can also be images or icons which represent a display according to the present invention. For instance, in the example of FIG. 1, graphical object 1a represents the current user of the system. Graphical object 1e is an image of a vehicle. 1e could be an image of a specific vehicle and provide a link to a classified ad for said vehicle. Alternatively, 1e could be an icon of a vehicle which is representative of another view in the GUI relating to cars the user prefers.

In the alternative scenario, when a user from the example screen of FIG. 1 selects graphical object 1e, then the view would change to a primary view with the focus object being the graphical object of 1e. Then any vehicle manufacturers, specific automobiles, car dealerships, insurance companies, or any other data which a user wants to group with the graphical object 1e can be displayed as additional graphical objects arranged in the view with respect to the focus object 1e.

Each of the graphical objects represented within the view of graphical object 1e would have a data indicator associating it with graphical object 1e as well as with graphical objects to which 1e is linked. Therefore, the system can determine preference data for the user represented by graphical object 1a involving preferred brands of cars based on the user's placement of where cars are important to the user represented by the placement of 1e in the users view and the placement of brands of cars within the car view of 1e.

Such associations and data indicators can extend for every association of every association and so on. However, in practice it is usually sufficient to only include associations and data indicators out to three associations. For example, in the example of FIG. 1 where the graphical object represents the user, the user could place graphical objects representing their friends and also have their graphical object placed in friends views. Then the associations and data indicators would be tracked only to friends of friends of friends, i.e. three associations.

The image representative of the graphical object can be set when added to a view or it can be updated by the graphical object owner, system or entity. If the entity represented is a website and the image is a miniaturized portion of the website, then the image could update in the user view whenever the website is updated. If the graphical object represents cars the user is interested in, then the image could be the image of the car that is indicated as the most relevant or important to the user in the car view. Therefore the image of the graphical object of cars would be updated automatically when the most relevant car is updated.

Examples of graphical objects, what they represent, the image or icon that is displayed, how said image or icon is chosen, etc. that has been disclosed herein is not limited to what has been explicitly described. One of ordinary skill in the art will recognize the usefulness of the underlying method of acquiring preference data through user interaction and manipulation of the data and objects present, regardless of the data and objects actual construction without departing from the scope of the present invention.

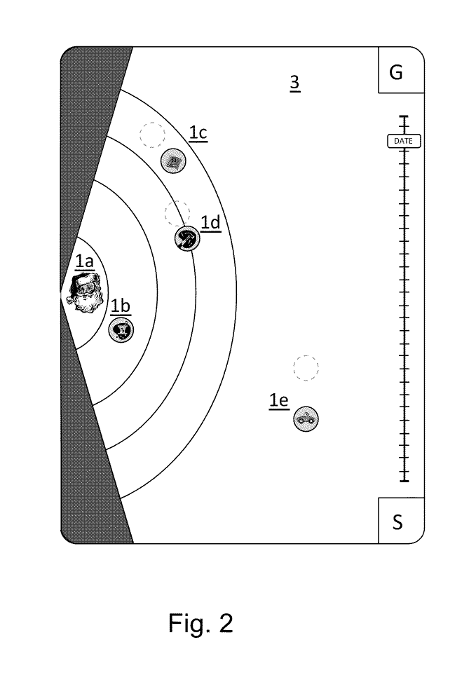

FIG. 2 shows an example of a display from a user interface in which the location of objects with respect to alternative views, for example past and future views when in the present view, is utilized in determining preference data. In the present embodiment, the position of graphical objects with respect to alternative views varies over time.

In the example, the user initially places each graphical object at a location which represents its relative importance to the user based on distance from the focus object as well as the relative importance based on timing based on the distance from the past view or future view. The graphical objects then travel across the screen at a set pace, or at set intervals of time. The pace or intervals can be set by the system or chosen by the user. Additionally the pace or intervals can be to consistent for all graphical objects on the screen or it can vary based on the distance from the focus object or based on any set boundaries.

FIG. 2 shows an outline of where each graphical object 1b-e was at a previous point in time and then where the graphical object is at the present point in time. It can be seen that the graphical objects furthest from the focus object traveled the furthest distance over the same time. Additionally it can be seen that the object 1b located in the space between the focus ring and the first ring 7 did not travel at all during the time.

The purpose of the traveling objects is to mimic the relevance of information for a user changing over time without the user having to constantly update the information in the display. Things that are very important to a user might not change level of importance for a long period of time and therefore the locations closest to the focus object may not alter the placement of contained graphical objects at all.

However, the relevance of objects that are not as important, such as 1e, located far from the focus object may change rapidly and therefore they may be moved quickly by the system. When changing the position of objects in the display without user interaction, it is preferable not to change the distance of the objects from the focus object as relative importance may not change at the same rate that relative relevance changes over time.

In FIG. 2, it can be seen that the location of the closest, and therefore relatively most important, object 1b does not change over time. However, objects 1c and 1d which are less important, but still within a distance defined by the rings 7 change relevance (future to past) over time without changing importance (distance from focus object). Objects outside of the rings, and therefore least important, such as object 1e change both relevance and importance overtime but moving substantially vertically top to bottom. This can be useful to a user as information that is initially located to represent that it is not important now but may be in the future, can increase in importance as it increases in time relevance.

Users can select the pace, interval and path of each object separately. Additionally, users can lock specific objects in place while other non-locked objects travel according to the predefined parameters. Users can also select, chose from preset options, or allow the system to automatically assign parameters to the display as a whole or to specific portions of the display defined by boundaries. If the system automatically assigns the system parameters, it can also update those parameters constantly, or at intervals based on the preference data of the user collected. For instance, if a user is regularly moving objects from one area of the display to the past view then the system can increase the rate at which objects in that area advance to the past section on their own.

Through the use of traveling graphical objects as described, preference data for the user is constantly, or at predefined intervals, being updated without user interaction so that their preference data is relevant and does not require constant user input. When graphical objects reach a boundary, such as the past view, they can automatically be removed from the present view and enter the past view or they can accumulate on the edge of the present view so the user can determine if they should be placed in the past view, replaced in the present view, deleted or otherwise manipulated.

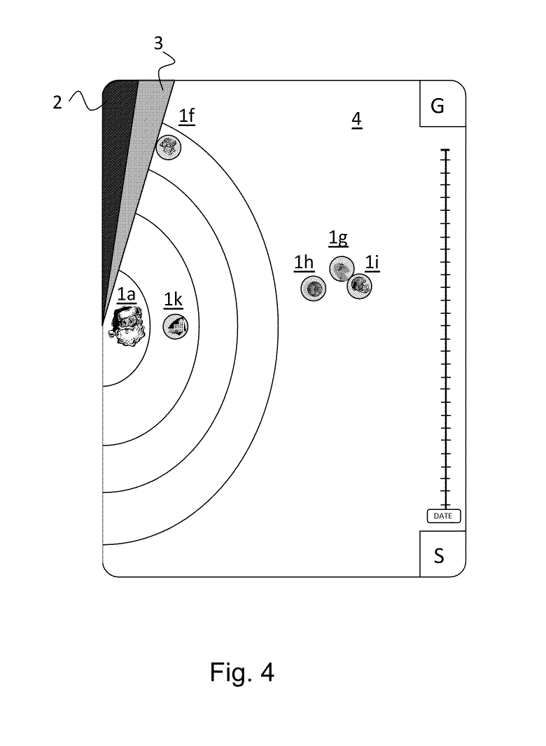

When multiple views are present in the GUI, the user can switch between the views in a variety of known manners. FIG. 4 shows a primary view of the past which is in accordance with the primary view of the present of FIG. 1. To get to the past view, a user could simply select the area representing the past from the present display or utilize other suitable method.

In the past view 4, there exists the same or similar set of rings 7. The functionality of the GUI and system in the past view is substantially similar to that of the present view. All of the objects in the past view are giving a data indicator that they are less relevant than anything located in the present view. Some of the functionality in the past view may be different or limited, such as if there are traveling objects in the present view, there may or may not be traveling objects in the past view, as it is less important that relevance changes in the past. Alternatively, the pace or intervals at which objects travel, and of their travel direction, may be selected different from that of the present view. Any other differences, options or functionalities disclosed with regards to the present view can be similar or different in the past view with respect to the present view, or the future view.

FIG. 4 shows an object 1f on the boarder of the present view representation 3. Objects can be placed there by the user or they can be placed there automatically by the system when objects are moved between views. If the object 1f traveled from an initial position selected by the user to the boundary of the past automatically and then was automatically placed in its current location automatically, it would preferably remain there until the user repositioned it with relative importance in the past view.

It can also be seen in FIG. 4 that the user has grouped several like graphical objects 1h representing soccer, 1g representing baseball and 1i representing American football near each other. The system can therefore determine easily that the user had a preference to sports in the past, specifically soccer, baseball and football, and that currently they are important to the user in that order, though all are less important than object 1k representing the users previous school.

The GUI and system can have a large number of tools which aid in the organization of information, and therefore the capability of the system to gather preference data. For instance, when the user places several like graphical objects together as in FIG. 4, the user could select a tool to graphically, or otherwise, encompass the like objects and create a new object.

As discussed above with regards to cars, the system could select an image or icon representative of the plurality of graphical objects and replace all of the current graphical objects with the new representative object. Concurrently, the system would place the selected graphical objects in a view of the new object in relative positions according to how they are displayed in the past view presently. This allows for a user to more accurately place graphical objects with respect to other like objects and clear space in the main user view.

One of ordinary skill in the art will recognize other applicable tools which can be utilized within the present system and GUI to facilitate the gathering of accurate preference data from a user based on the users input without departing from the scope of the present invention.

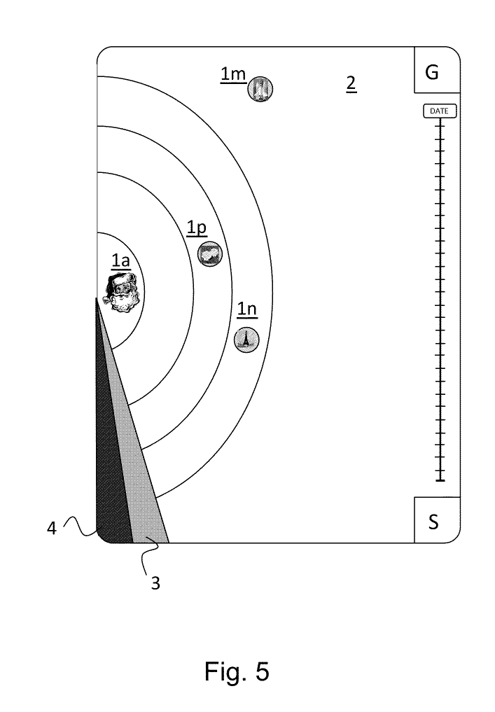

FIG. 5 shows a primary view of the future which is in accordance with the primary view of the present of FIG. 1. The user can access the future view 2 in the same or similar manner as that of the past view discussed above. The future view, its operation and functionality is substantially the same as the past and present views. Specifically, the operation and functionality can be the same as the past, the present, the past and present or distinct from the past and present based on user preferences or system settings.

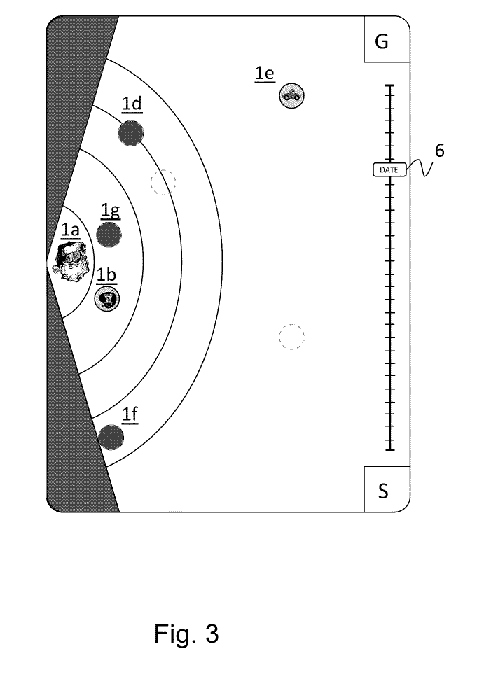

Optionally displayed in each view, especially within primary views, are a dateline 5 and a date indicator 6. One exemplary function of the date bar is to provide a control for graphically displaying time data of graphical objects. FIG. 3 shows an embodiment where moving the date indicator changes the display of graphical objects on the display. The date indicator 6 has been moved to a portion of the dateline representing a time previous to the time of FIG. 1. The dotted outline of the moved objects 1d and 1e can be shown or not.

An aspect of the date bar is that by moving the date indicator 6 to a specific date graphically shows time data about present at the selected date. Comparing FIG. 1 and FIG. 3 will show that at the time FIG. 3 is displaying there were objects 1b, 1d, 1e, 1f and 1g while currently there are only objects 1b-e in the present view. Aside from just showing what objects were present at a previous date, only objects added on that date, or in a predefined interval around that date such as a week or month, are shown normally. Objects added before the time or interval are shown in a modified manner, such as grayed out. Additionally, the path taken by the objects, manner in which they were moved or modified, or indication of current location can be shown.

The concept of linking a data bar and date indicator to information on a display or in a GUI so that manipulation of the date indicator along the bar graphically modifies the information displayed to show time data can be applied outside of the present GUI or in virtually any portion of the present GUI. Therefore, the disclosure of a linked date bar and indicator as described herein are not limited to implementation in the present GUI disclosure.

When there are a plurality of views, such as primary, secondary and tertiary views, a user can switch from one view to another in a variety of ways. One exemplary manner would be by pressing the focus object once, which switches to the next view, i.e. from a primary to a secondary or from one primary to another primary etc. The user can independently choose the order of the views in a Settings view. When the user is in the final view, pressing the focus object one time takes the user back to the first view.

In one embodiment, shown in FIG. 7, the user can measure where in the cycle of views they are by the position of a glowing color 23 around the edge of the focus object, or the focus object ring. For example, if there are three views relating to a specific focus object 21a, 21b and 21c, the glowing color would be 33% of the half oval shown of the focus object or focus object ring.

When the first view is displayed, the glowing color would be the top 33% of the edge of the focus object. When the second view is displayed, the glowing color would be shown on the 24%-66% of the edge of the focus gob. Additional views would be arranged similarly.

An example of a secondary view 20 is shown in FIG. 7. Secondary views may contain the focus object in the same, similar or different position as any primary or tertiary views. Secondary views may have other graphical objects in them, but they are characterized by having expanded information represented by blocks 22. This expanded information could be a feed comprised of information from the collection of graphical objects of the focus object. It can also be search results, webpages, data or information specific to the focus object or a selected graphical object.

Views can also contain collections of graphical objects. The user can move a graphical object in a collection to the focus gob position, for example by double-tapping in a touch interface or double-clicking in a mouse and keyboard interface on a non-focus graphical object.

In an embodiment, a user can navigate back and forth between different graphical objects by, for example, tapping and holding the focus object and then dragging it to the right. This opens a navigation string shown in FIG. 6. Many other suitable methods for accessing a navigation screen will be apparent to those skilled in the art.

An aspect of a secondary view is that it can show all graphical objects in a plurality of primary views and can be scrolled.

Graphical objects can appear in a secondary view in a variety of orders and preferably are initially displayed in an order based on the preference data collected by the system from the user. Graphical objects can be ordered according to perceived time relevance from oldest 1k to most future 1n from FIGS. 1-5. The initial manner in which the graphical objects are displayed in the navigation bar may be set or selectable by the user in a settings menu.

Graphical objects can also be reordered in a secondary view, for example by taping and holding until the graphical objects shimmer, then dragging and dropping them in the desired location along a single axis. It is preferable that the objects are reordered linearly in the a secondary view along an axis so that the order is clearly represented to the user.

In the case where graphical objects can be opened and navigated within it becomes useful to have a navigation screen as shown in FIG. 6. If a user opens a graphical object and then opens another graphical object from the previous then the order in which the objects were viewed can be shown on a navigation string. The user can then go back, or ahead a certain number of graphical object from the navigation screen without having to go back through each one separately.

Graphical objects can also be closed from the navigation string, for example by taping and holding until the graphical object shimmers and then dragging the graphical object downward. Similarly, all graphical objects can also be closed by taping, holding and dragging the focus gob downward. Optionally, a user can add a graphical object to the focus objects collection from a secondary view, or tertiary view, for example by taping, holding and dragging the desired graphical object onto the focus object. Additionally, if a user has control over multiple graphical objects, they can add graphical objects to owned non-focus graphical objects in a similar manner. A user may also access a menu of actions specific to a graphical object by tap, hold and releasing a graphical object.

In primary, or collection views, there is optionally a timeline which is shown on the right hand side as discussed above. A similar date bar can be added to a secondary view. Sliding an indicator to a particular date can enlarge, bold, or show normal the graphical objects added to a collection on that date and minimize, grey or otherwise distort or change the other graphical objects that were in the collection at that time. Graphical objects not in the collection at that date will preferably not be shown. Double-clicking the date bar on a given date can make all graphical objects in a collection on that date the same.

The following is an exemplary embodiment of the present method, graphical user interface and associated system enables an end user to intuitively collect and share information on his personal preferences and priorities through the relational placement of the graphical objects. This information can then, preferably with the express permission of the end user, be used by Internet services to deliver highly personalized services. The present method and graphical user interface allows a computer system to measure user preferences and perceptions and to use that information for Internet services to deliver highly customized versions of their service.

User preference data is collected when users add a graphical object to their collection, normally primary, view and consciously places the gob in a position relative to the focus gob which represents the user or some specific aspect relative to the user, i.e. cars the user is interested in. As shown in the FIGS. 1-5, the collection view is divided into three sections, one corresponding to graphical objects that relate to the user historically or in the past 4, one section that corresponds to graphical objects that relate to the user presently 3, and one section that corresponds to graphical objects that relate to the user in the future 2.

These sections expand or collapse to maximize screen space, especially for viewing on a mobile device. These three sections will always be in the denoted order and relative positions, regardless of their size. Within each section, graphical objects can be placed relative to the user, focus object. The closer a graphical object is placed to the user, the higher the level of denoted preference and/or relevance to the user.

Based on this placement, the following data is collected for each graphical object:

1) User perception of time relevance to himself (historical, present or future)—based on physical placement of a gob into one of the three sections

2) User perception of preference or importance to himself—based on distance of physical placement of gob from the focus gob

3) Time the gob was added to the collection

The data collected on each graphical object is processed by the system and the system compares this to the data for every other graphical object in a user's collection. The system then produces user preference data based on the collected and processed data which can be fed to Internet services for the personalization of those services, for example via its Internet cloud-based API.

For example, if a user has a graphical object representing a Ford auto in the present section and a graphical object representing a BMW auto in his future section, the system could assume an aspirational preference for BMW. If the user then has a third graphical object representing a Fiat auto in his present section, but it is further away from the focus object than the Ford, the system could assume a current preference for Ford over Fiat.

In this scenario, the system could feed this data to a used car search service. The service could use this data to deliver search results where BMW, Ford and Fiat (in that order) are prioritized in the search results.

Time data on when a graphical object is placed in a user's collection is also collected and used by the system. In the system, when objects are placed in more or less the same location, the more recently placed gob is measured as having a slightly higher level of preference than the older gob.

In addition to using the data in a user's own collection, the system also incorporates data from a user's network, i.e. the collections of graphical objects in a user's collections, to the third level.

In the above auto example, if the end user has a friend in his collection and she has an Opel graphical object in her collection, the car search service would then deliver prioritized search results with Opel before other brands that were not in the end-user's collection.

The system uses similar methods to suggest new graphical objects for a user to collect. It does this by analyzing the graphical objects in the collections of the graphical objects in the user's collection and network. Based on factors such as frequency, relevance, time, type, and the user's settings, new graphical objects are suggested to the user to collect. These recommended graphical objects can be in the form of recommendation messages and top 10-type lists.

Additionally, recommended graphical objects can be displayed within a collection view such as in FIG. 8. FIG. 8 shows a hybrid collection and suggestion view 30 which shows suggested graphical objects for collection of 32a and 32b. Preferably, the suggested graphical objects are distinguishable over the user's current graphical object such as by the additional boundary stars in the Figure.

Suggested graphical objects can be placed in a generic portion of the display so that a user knows that they are present, or they can be placed in specific portions of the display depending on what they are suggesting. In FIG. 8, suggested graphical object 32a is a new car and is placed near or adjacent to the users current graphical object 1e representing a different car. Such a suggested graphical object could be a form of paid advertising.

Suggested graphical object 32b, representing a doctor's office, is based on both graphical objects 1d, representing a heavy machinery rental, and 1b, the user's medicine. The system can determine that both are important and relevant to the user. Additionally, the system can determine that the medicine should not be used with heavy machinery and therefore recommend a doctor's office 32b to the user. The doctor's office can be a paid advertisement or it can be a doctor's office found in, or the most frequently one found in the users network and not a paid advertisement.

Alternatively, or concurrently, the hybrid view 30 can contain an advertisement or suggestion block 31. The content of the block 31 can be paid advertisement that is either generic or based on the user's preferences and collection of graphical objects. The content of the block 31 can also be the recommendation messages and top 10-type lists described above.

A user can also choose to explore for new graphical objects. When exploring, groups of graphical objects can be presented. These groups are preferably arranged via a pre-established, nested grouping like those found in a lexicon. Within each of these groups, graphical objects are presented in a prioritized manner, with those graphical objects within a user's network preferably given prominence.

The graphical user interface of the present invention is stored on a computer readable medium. Examples of said computer readable medium can be such as generic to a plurality of system components, i.e. stored on a server and accessible by mobile devices, web browsers or workstations or specific to each system device, i.e. as a hard drive having computer readable instructions downloaded or loaded on or portable computer readable mediums, i.e. CD-ROM or the like.

Additionally, a system utilizing the present method and or graphical user interface can contain any plurality of components not described herein such as a storage medium for storing some or all of the collected data or preference data. The system is also preferable connected to a network such as the internet to allow communication between various user's interfaces.

The present invention is not limited to the examples described herein. The examples and exemplary embodiments are used as an aid to describe the invention. One of ordinary skill in the art will recognize variations on the disclosed examples and embodiments which do not depart from the scope of the present invention.

1. A method of generating user preference data, in a computer system, based on user interaction with a graphical user interface, the method comprising the computer implemented steps of;
providing a graphical user interface to the user,
making available a plurality of graphical objects in the graphical user interface, the graphical objects representative of some data, information or entity,
selecting a single graphical object as a focus object and locating that object in a fixed position of a display of the graphical user interface,
enabling a user to place and manipulate the plurality of non-focus object graphical objects in relation to the focus object in the display,
gathering data representative of at least the relative position of each graphical object with respect to the focus object,
determining at least one preference of the user based on the gathered data, and
utilizing the at least one preference data to modify the performance of the system for the user.

2. A method according to claim 1 further comprising the step of,
making the preference data available to a third-party service to modify the performance or results of the third-part service for the user based on the preference data.

3. A method according to claim 1 wherein,
making available a plurality of graphical objects includes allowing the user to create and modify some or all of the plurality of graphical objects.

4. A method according to claim 1 wherein the graphical user interlace has multiple views, at least one view represents the present and at least one other view represents the future or the past, and
enabling the user to place and manipulate the plurality of non-focus object graphical objects in the plane of the display in relation to the focus object as well as simultaneously in relation to a representation of the at least one other view.

5. A method according to claim 4, wherein the data gathered of each graphical object includes a plurality of data selected from the group of; distance from the focus object, distance from the at least one other view, distance from another non-focus object graphical object, date added to the graphical user interface, date created, amount of times viewed, amount of times modified, amount of times moved, last time viewed, last time modified, last time moved and view in which the graphical object is currently located.

6. A method according to claim 5, wherein the determined preference data includes perceived importance data of the user based on the distance of each graphical object from the focus object and perceived time relevance of each graphical object based on the distance of each graphical object from the representation of the at least one other view.

7. A method according to claim 4 further comprising the steps of,
associating with each non-focus object graphical object at least one data indicator selected from the group of; distance from the focus object, distance from the at least one other view, distance from another non-focus object graphical object, date added to the graphical user interface, date created, amount of times viewed, amount of times modified, amount of times moved, last time viewed, last time modified, last time moved and view in which the graphical object is currently located, and
wherein gathering data representative of at least the relative position of each graphical object to the focus object involves gathering one or more data indicators from each graphical object.

8. A computer readable medium having stored there on computer implementable instructions for generating user preference data from user interaction with the computer implementable instructions, the computer readable medium causing a computer to execute;
displaying a first view of a graphical user interface having more than one user selectable views,
displaying a plurality of user manipulatable graphical objects in the graphical user interface, the graphical objects representative of some data, information or entity,
selecting a single graphical object as a focus object and locating that object in a fixed position of the first view of the graphical user interface,
gathering data representative of at least the relative position of each user manipulated graphical object with respect to the focus object,
determining at least one preference of the user based on the gathered data, and
utilizing the at least one preference data to modify the performance of the system for the user.

9. A computer readable medium in accordance with claim 8 causing a computer to further execute;
saving at least the gathered data or the determined preference in a storage medium accessible by the computer.

10. A computer readable medium in accordance with claim 8, wherein the graphical user interface has at least one primary view representing the present and having a first plurality of graphical objects, at least one other primary view representing either the past or the future having a second plurality of graphical objects distinct from the first, and at least one secondary view capable of having graphical objects from a plurality of primary views.

11. A computer readable medium in accordance with claim 10, wherein in gathered data includes a data indicator of the primary view a graphical object is located in.

12. A computer readable medium in accordance with claim 8, wherein utilizing the preference data to modify the performance of the system includes displaying suggested content in a view of the graphical user interface.

13. A computer readable medium in accordance with claim 12, wherein the suggested content is advertising and it is shown as one or more manipulatable graphical objects in a primary view of the graphical user interface.

14. A computer readable medium in accordance with claim 12, wherein the suggested content is advertising and it is shown as one or more manipulatable graphical objects in a tertiary view of the graphical user interface for displaying suggested content.
